(19) United States
(12) Patent Application Publication
(10) Pub. No.: US 2025/0114769 A1
(43) Pub. Date: Apr. 10, 2025

(54) CATALYST FOR LIQUID PHASE REFORMING OF BIOMASS DERIVED FROM HYDROTALCITE, METHOD FOR PREPARING THE SAME, AND METHOD FOR PRODUCING HYDROGEN USING THE SAME

(71) Applicant: KOREA INSTITUTE OF SCIENCE AND TECHNOLOGY, Seoul (KR)

(72) Inventors: Sun-Hee Choi, Seoul (KR); Hyuntae Sohn, Seoul (KR); Suk Woo Nam, Seoul (KR); Sung Pil Yoon, Seoul (KR); Yong Min Kim, Seoul (KR); Hyangsoo Jeong, Seoul (KR); Yoondo Kim, Seoul (KR); Owen Khosashi, Seoul (KR)

(21) Appl. No.: 18/901,539

(22) Filed: Sep. 30, 2024

(30) Foreign Application Priority Data
Oct. 4, 2023 (KR) 10-2023-0131602

(51) Int. Cl. B01J 23/00; B01J 23/80; B01J 37/03; B01J 37/06; B01J 37/08; B01J 37/18; C01B 3/12; C01B 3/32

(52) U.S. Cl. CPC B01J 23/002; B01J 23/80; B01J 37/031; B01J 37/06; B01J 37/088; B01J 37/18; C01B 3/12; C01B 3/326; B01J 2523/27; B01J 2523/31; B01J 2523/847; C01B 2203/0233; C01B 2203/0283; C01B 2203/1058; C01B 2203/1076; C01B 2203/1211

(57) ABSTRACT

The present disclosure discloses a catalyst for liquid phase reforming of biomass derived from hydrotalcite, a method for preparing the same, and a method for producing hydrogen using the same. The catalyst is a mixed metal oxide catalyst, the catalyst is a nickel-zinc-aluminum mixed metal oxide of a hydrotalcite structure, and the catalyst is used for liquid phase reforming of biomass. The catalyst has an effect of providing a high yield of hydrogen by improving an efficiency of the liquid phase reforming reaction of biomass.

### CROSS REFERENCE TO RELATED APPLICATION

The present application claims the priority of Korean Patent Application No. 10-2023-0131602, filed on Oct. 4, 2023, the entire contents of which are incorporated herein for all purposes by this reference.

### BACKGROUND OF THE INVENTION

### Field of the Invention

The present disclosure discloses a catalyst for liquid phase reforming of biomass derived from hydrotalcite, a method for preparing the same, and a method for producing hydrogen using the same.

### Description of Government-Sponsored Research

This research was conducted at the Korea Institute of Science and Technology under the management of the National Research Foundation of Korea which is affiliated with the Ministry of Science and ICT. The research business name is Development of Innovative Hydrogen Energy Technology, and the research project name is Development of a Renewable Hydrogen Production Process from an Unused C5 Organic Compound Derived from Biomass (Unique project identification number: 1055001140, Project identification number: 2019M3E6A1104113).

### Description of the Related Art

South Korea, which ranks within the top 10 in the world in terms of energy consumption, is an energy resource-poor country and relies on an import for most of major energy sources. Further, the development of next-generation energy sources is required as carbon dioxide and environmental pollutants, which cause the greenhouse effect, are released into an atmosphere due to the use of enormous energy sources. In order to settle the environmental problems such as global warming and reduce dependence on fossil fuel-based energy sources, hydrogen is receiving great attention as a next-generation energy carrier. In order to produce a large amount of hydrogen, reforming reactions of a natural gas or a synthetic gas produced through coal gasification are currently widely used. In this case, an upcycle process is possible when hydrogen is produced from biomass obtained from a sewage sludge or a food waste by replacing the existing hydrogen production reaction, and this process can be said to be very economical as high value-added products can be produced from the unused materials.

Various processes can be used to produce a biogas (H₂, CH₄, etc.) from biomass, and among them, a steam reforming reaction, which is a catalytic reaction using steam of a high temperature, is the most widely used. However, when the biogas is produced from biomass through a series of steam reforming reactions, this steam reforming process produces various reaction by-products such as hydrogen, methane, carbon monoxide, and carbon dioxide together, thereby essentially requiring an additional separation process to employ the produced hydrogen as the energy carrier. In addition, the steam reforming reaction proceeds at a high temperature, which results in having a disadvantage of relatively low thermal efficiency. Accordingly, interest in liquid phase reforming has recently increased as a means of solving this problem. The liquid phase reforming is a catalytic reaction that proceeds at a low temperature of 300° C. or less and can convert biomass from liquid phase reactants at a high pressure. In particular, in case the biomass dispersed in an aqueous solution is applied to produce hydrogen through the liquid phase reforming, carbon monoxide, which may be generated as the reaction by-product, may be converted into carbon dioxide and hydrogen through a water gas shift (WGS) reaction, thereby making possible it to produce hydrogen that does not contain carbon monoxide, which may cause poisoning of rare metal-based electrodes in a fuel cell.

Since the liquid phase reforming mechanism of biomass involves a selective cleavage of C—C, C—H, and C—O bonds in a hydrocarbon by a catalytic reaction, in order to further improve the selectivity of hydrogen as the energy carrier, a dehydrogenation reaction must be selectively promoted instead of the hydrogenation reaction.

### SUMMARY OF THE INVENTION

In an aspect, a purpose of the present disclosure is to provide a mixed metal oxide catalyst for liquid phase reforming of biomass.

In other aspect, a purpose of the present disclosure is to provide a method for preparing a mixed metal oxide catalyst for liquid phase reforming of biomass.

In another aspect, a purpose of the present disclosure is to provide a method for producing hydrogen using a mixed metal oxide catalyst for liquid phase reforming of biomass.

In an aspect, the present disclosure provides a mixed metal oxide catalyst, wherein the catalyst is a nickel-zinc-aluminum mixed metal oxide of a hydrotalcite structure, and the catalyst is for liquid phase reforming of biomass.

In an exemplary embodiment, a molar ratio of the mixed metal of nickel and zinc to the aluminum metal in the catalyst may be 1 to 4.

In an exemplary embodiment, a molar ratio of the nickel metal to the zinc metal in the catalyst may be 2 to 4.

In an exemplary embodiment, the catalyst may be for liquid phase reforming of xylose.

In an exemplary embodiment, the catalyst may produce carbon monoxide and hydrogen from liquid reactants of biomass through a liquid phase reforming reaction of biomass, wherein the carbon monoxide may react with water to produce hydrogen and carbon dioxide.

In other aspect, the present disclosure provides a method for preparing the mixed metal oxide catalyst, the method comprising the steps of: preparing a metal precursor solution A containing a nickel precursor, an aluminum precursor, and a zinc precursor; preparing a solution B containing sodium hydroxide and sodium carbonate; allowing a mixed solution of the solution A and the solution B to leave at 50 to 80° C., followed by filtering it to obtain a filtered hydroxide; and adjusting a pH of the filtered hydroxide to 6 to 8, followed by drying and calcining it.

In an exemplary embodiment, the method may comprise washing the filtered hydroxide with a distilled water at 80 to 90° C. until a pH thereof reaches 6 to 8, followed by drying and calcining it.

In an exemplary embodiment, the drying and calcining may be performed at 80 to 100° C. and 400 to 600° C., respectively.

In other aspect, the present disclosure provides a method for producing hydrogen, the method comprising producing hydrogen from liquid reactants of biomass through reaction of the mixed metal oxide catalyst.

In an exemplary embodiment, the step of producing hydrogen may be performed at a temperature of 200 to 300° C. and a pressure of 20 to 50 bar.

In an exemplary embodiment, the method may comprise forming carbon monoxide and hydrogen from the liquid reactants of biomass, and reacting the carbon monoxide and water to form hydrogen and carbon dioxide through a water gas shift (WGS) reaction.

In an aspect, the technology disclosed in the present disclosure has an effect of providing a mixed metal oxide catalyst for liquid phase reforming of biomass.

In other aspect, the technology disclosed in the present disclosure has an effect of providing a method for preparing a mixed metal oxide catalyst for liquid phase reforming of biomass.

In another aspect, the technology disclosed in the present disclosure has an effect of providing a method for producing hydrogen using a mixed metal oxide catalyst for liquid phase reforming of biomass.

### BRIEF DESCRIPTION OF THE DRAWINGS

FIG. 1 shows SEM analysis results of a catalyst according to an embodiment.

FIG. 2 shows TPR analysis results of a catalyst according to an embodiment.

FIG. 3 shows BET analysis results of a catalyst according to an embodiment.

FIG. 4 shows STEM-EDS analysis results of a catalyst according to an embodiment.

FIG. 5 shows STEM-EDS analysis results of a catalyst according to an embodiment.

FIG. 6 shows results of a liquid phase reforming reaction of xylose using a catalyst according to an embodiment.

FIG. 7 shows results of a liquid phase reforming reaction of xylose using a catalyst according to an embodiment.

FIG. 8 shows results of a liquid phase reforming reaction of xylose using a catalyst according to a Comparative Example.

FIG. 9 shows STEM analysis results after calcination of a catalyst according to an embodiment.

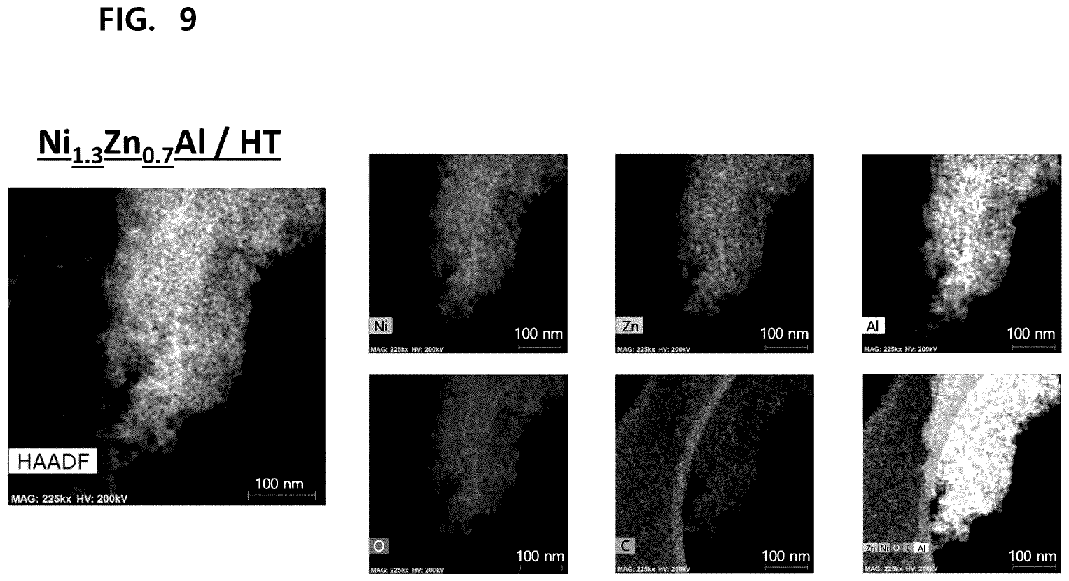

FIG. 10 shows STEM analysis results after reduction of a catalyst according to an embodiment.

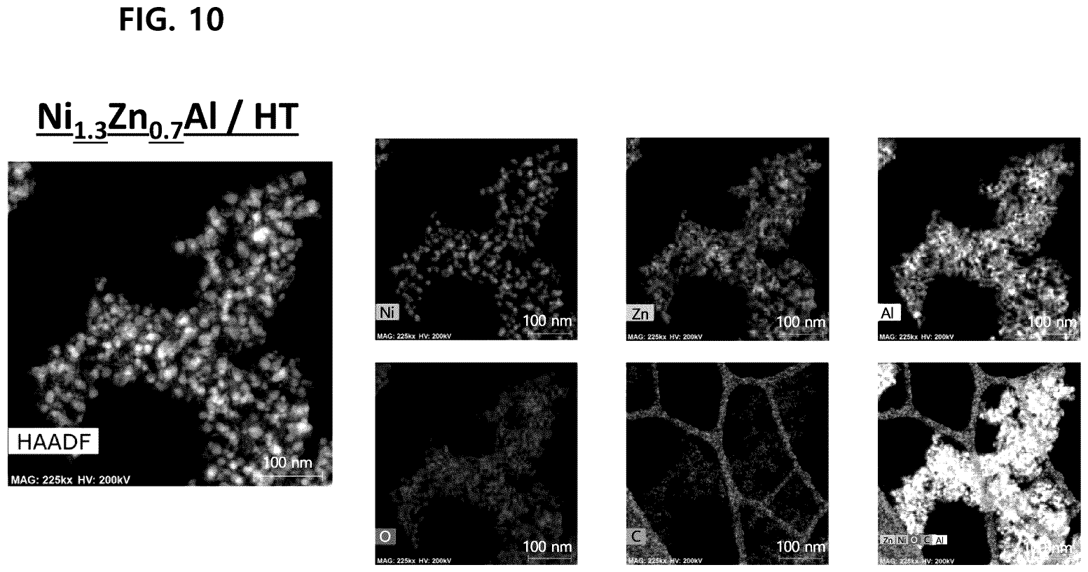

FIG. 11 shows STEM analysis results after a liquid phase reforming reaction of xylose for 100 hours with a catalyst according to an embodiment.

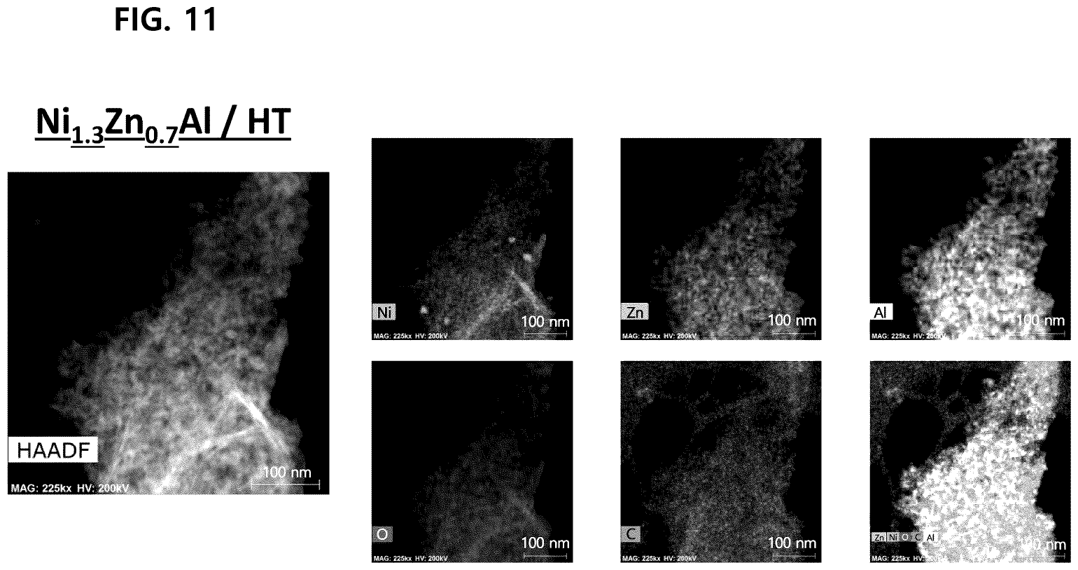

### DETAILED DESCRIPTION OF THE INVENTION

Hereinafter, the present disclosure will be described in detail.

In an aspect, the present disclosure provides a mixed metal oxide catalyst, wherein the catalyst is a nickel-zinc-aluminum mixed metal oxide of a hydrotalcite structure, and the catalyst is used for liquid phase reforming of biomass.

The hydrotalcite is an anionic clay having a layered double hydroxide structure, and has the structural formula as follows.

M(II)_{X}M(III)_{Y}(OH)_{N}(A^{m-})_{Z}·nH₂O
wherein M (II) is a divalent metal such as Mg²⁺, Ni²⁺, and Zn₂₊, M(III) is a trivalent metal such as Al³⁺, Fe³⁺, Cr³⁺, and Co³⁺, and A^{m-} is an anionic substance consisting of CO²⁻₃, OH⁻, NO³⁻, SO²⁻₄, halogenide, etc.

The hydrotalcite is a metal compound consisting of double layers of two or more metals and has various uses by capturing anions between the double layers. The hydrotalcite consists of the double layers so that it is also called as LDHs (Layered double hydroxides) or MMLHs (mixed-metal layered hydroxides). Recently, the hydrotalcite is used by modifying its crystal structure at a high temperature and other conditions, and is also used without crystalline water by making n=0. In addition, substances similar to the hydrotalcite are prepared by combining various metals in various ways, and these substances are called as a hydrotalcite derivative, a hydrotalcite-like compound, etc.

A metal hydroxides with the hydrotalcite structure are characterized by very high dispersion and uniformity of active metal components because the divalent metal and the trivalent metal are uniformly combined to form a layered structure. However, since the metal hydroxide of the hydrotalcite structure must form a layered double structure, and vary a type and ratio of suitable metals depending on its specific use, when synthesized, the synthesis conditions such as a type, concentration, time, and temperature of raw material precursor components, and a ratio of the raw material components must be precisely controlled.

The catalyst according to the present disclosure is a hydrotalcite-like compound containing nickel, zinc, and aluminum, and has an effect of further improving activity of the catalyst for liquid phase reforming of biomass by adjusting a molar ratio between the metals.

If a molar ratio of M²⁺(Ni, Zn)/M³⁺(Al) increases, the formation of Ni(OH)₂ and Zn(OH)₂ increases, and if the molar ratio of M²⁺(Ni, Zn)/M³⁺(Al) decreases, the formation of Al(OH)₂ increases. Catalysts derived from the hydrotalcite-like compound have different catalytic activities depending on their components, and the molar ratio affects a size and dispersion of the metal particles, which changes the liquid phase reforming performance of biomass. The present disclosure has an effect of providing a catalyst having high hydrothermal stability and coking formation resistance along with excellent catalytic activity.

In an exemplary embodiment, a molar ratio of the mixed metal of nickel and zinc to aluminum metal in the catalyst may be 1 to 4. More specifically, a molar ratio of the mixed metal of nickel and zinc to aluminum metal in the catalyst may be adjusted to 1 to 2 to provide the performance of excellent liquid phase reforming reaction and the technical advantage of producing a more amount of hydrogen from the same amount of biomass. In other words, it has an effect of providing a high yield of hydrogen by improving efficiency of the liquid phase reforming reaction of biomass.

In an exemplary embodiment, a molar ratio of nickel metal to zinc metal in the catalyst may be 2 to 4. More specifically, adjustment of the molar ratio of nickel metal to zinc metal in the catalyst to 2 to 3 or 3 to 4 can provide the performance of excellent liquid phase reforming reaction and the technical advantage of producing a more amount of hydrogen from the same amount of biomass. In other words, it has an effect of providing a high yield of hydrogen by improving efficiency of the liquid phase reforming reaction of biomass.

In an exemplary embodiment, the catalyst may be used for liquid phase reforming of xylose.

In an exemplary embodiment, the catalyst may produce hydrogen through liquid phase reforming of xylose.

In other aspect, the present disclosure provides a method for preparing the mixed metal oxide catalyst, the method comprising the steps of: preparing a metal precursor solution A containing a nickel precursor, an aluminum precursor, and a zinc precursor; preparing a solution B containing sodium hydroxide and sodium carbonate; allowing a mixed solution of the solution A and the solution B to stand at 50 to 80° C., followed by filtering it to obtain a filtered hydroxide; and adjusting a pH of the filtered hydroxide to 6 to 8, followed by drying and calcining it.

In an exemplary embodiment, the nickel precursor, aluminum precursor, and zinc precursor may be one or more selected from the group consisting of salt compounds, acetate compounds, halogen compounds, nitrate compounds, hydroxide compounds, carbonyl compounds, sulfate compounds, and fatty acid salt compounds, respectively.

In an exemplary embodiment, the method may comprise washing the filtered hydroxide with a distilled water at 80 to 90° C. until a pH thereof reaches 6 to 8, followed by drying and calcining it.

In an exemplary embodiment, the drying and calcining may be performed at 80 to 100° C. and 400 to 600° C., respectively.

In an exemplary embodiment, the method may further comprise reducing by adjusting reduction conditions including a temperature and a gas composition after the calcining.

In an exemplary embodiment, the reduction step may be performed at a temperature of 600 to 800° C. under a hydrogen atmosphere for 1 to 5 hours.

In another aspect, the present disclosure provides a method for producing hydrogen, the method comprising producing hydrogen from liquid reactants of biomass through reaction of the mixed metal oxide catalyst.

In still another aspect, the present disclosure provides a method for producing hydrogen, the method comprising producing hydrogen by adding liquid reactants of biomass to the mixed metal oxide catalyst.

In an exemplary embodiment, the liquid reactants of biomass may include xylose.

In an exemplary embodiment, the liquid reactants of biomass may be xylose.

The method for producing hydrogen according to the present disclosure has an effect of enabling hydrogen production of a high efficiency and high purity through high carbon conversion rate and hydrogen yield.

In an exemplary embodiment, the step of producing hydrogen may be performed at a temperature of 200 to 300° C. and a pressure of 20 to 50 bar.

In an exemplary embodiment, according to the method for producing hydrogen, carbon monoxide and hydrogen may be formed from the liquid reactants of biomass through reaction of the mixed metal oxide catalyst.

In an exemplary embodiment, the mixed metal oxide catalyst may form carbon monoxide and hydrogen by selectively cleaving bonds of C—C, C—H, C—OH, CO—H, etc. contained in the liquid reactants of biomass. For example, if the CO—H bond is cleaved and dehydrogenation reaction occurs, hydrogen is produced, and if the C—OH bond is cleaved and dehydration reaction occurs, hydrogenation reaction occurs again to produce a hydrocarbon such as methane.

In an exemplary embodiment, the method for producing hydrogen may comprise forming carbon monoxide and hydrogen from the liquid reactants of biomass, and then reacting the carbon monoxide and water to form hydrogen and carbon dioxide through a water gas shift reaction. Specifically, the water gas shift reaction may be as follows.

CO+H₂O↔CO₂+H₂

Hereinafter, the present disclosure will be described in more detail through Examples. It will be apparent to those skilled in the art that since these Examples are to merely illustrate the present disclosure, the scope of the present disclosure should not be construed to be limited by these Examples.

### Example 1. Synthesis of Ni_{0.7}Zn_{0.3}Al-HT Catalyst

A solution A was prepared by dissolving 9.75 g of nickel nitrate hexahydrate, 18.87 g of aluminum nitrate nonahydrate, and 4.99 g of zinc nitrate hexahydrate in 31.66 mL of a distilled water. A solution B was prepared by dissolving 12.67 g of sodium hydroxide (NaOH) and 2.00 g of sodium carbonate (Na₂CO₃) in 126.72 mL of a distilled water. The prepared solution A was dropped into the solution B to prepare a mixed solution, and then the mixed solution was left at 60° C. for 18 hours. Thereafter, the precipitates, that is, the filtered hydroxide, were obtained through a filter and washed with a distilled water at 90° C. until a pH thereof reached 7. After drying the washed hydroxide, the temperature was raised at a heating rate of 5° C./min and calcined in air at 450° C. for 4 hours to obtain a nickel-zinc-aluminum mixed metal oxide catalyst of a hydrotalcite structure having M²⁺(Ni, Zn)/M³⁺(Al)=1 and Ni/Zn=2.

### Example 2. Synthesis of Ni_{1.3}Zn_{0.7}Al-HT Catalyst

A catalyst was synthesized in the same method as that of Example 1 to obtain a nickel-zinc-aluminum mixed metal oxide catalyst of a hydrotalcite structure having M²⁺(Ni, Zn)/M³⁺(Al)=2 and Ni/Zn=2, except that 9.75 g of nickel nitrate hexahydrate, 9.43 g of aluminum nitrate nonahydrate, and 4.98 g of zinc nitrate hexahydrate were dissolved in 31.66 mL of a distilled water to prepare a solution A and 6.33 g of sodium hydroxide (NaOH) and 1.00 g of sodium carbonate (Na₂CO₃) were dissolved in 63.36 mL of a distilled water to prepare a solution B.

### Example 3. Synthesis of Ni_{2.6}Zn_{1.4}Al-HT Catalyst

A catalyst was synthesized in the same method as that of Example 1 to obtain a nickel-zinc-aluminum mixed metal oxide catalyst of a hydrotalcite structure having M²⁺(Ni, Zn)/M³⁺(Al)=4 and Ni/Zn=2, except that 9.75 g of nickel nitrate hexahydrate, 4.72 g of aluminum nitrate nonahydrate, and 4.99 g of zinc nitrate hexahydrate were dissolved in 31.66 mL of a distilled water to prepare a solution A and 3.17 g of sodium hydroxide (NaOH) and 0.5 g of sodium carbonate (Na₂CO₃) were dissolved in 4.51 mL of a distilled water to prepare a solution B.

### Example 4. Synthesis of Ni_{1.0}Zn_{1.0}Al-HT Catalyst

A catalyst was synthesized in the same method as that of Example 1 to obtain a nickel-zinc-aluminum mixed metal oxide catalyst of a hydrotalcite structure having M²⁺(Ni, Zn)/M³⁺(Al)=2 and Ni/Zn=1, except that 9.75 g of nickel nitrate hexahydrate, 12.58 g of aluminum nitrate nonahydrate, and 9.97 g of zinc nitrate hexahydrate were dissolved in 31.66 mL of a distilled water to prepare a solution A and 8.45 g of sodium hydroxide (NaOH) and 1.33 g of sodium carbonate (Na₂CO₃) were dissolved in 84.5 mL of a distilled water to prepare a solution B.

### Example 5. Synthesis of Ni_{1.6}Zn_{0.4}Al-HT Catalyst

A catalyst was synthesized in the same method as that of Example 1 to obtain a nickel-zinc-aluminum mixed metal oxide catalyst of a hydrotalcite structure having M²⁺(Ni, Zn)/M³⁺(Al)=2 and Ni/Zn=4, except that 9.75 g of nickel nitrate hexahydrate, 7.86 g of aluminum nitrate nonahydrate, and 2.50 g of zinc nitrate hexahydrate were dissolved in 31.66 mL of a distilled water to prepare a solution A and 5.28 g of sodium hydroxide (NaOH) and 0.83 g of sodium carbonate (Na₂CO₃) were dissolved in 52.80 mL of a distilled water to prepare a solution B.

### Comparative Example 1. Synthesis of C01.3Zn_{0.7}Al-HT Catalyst

A solution A was prepared by dissolving 9.77 g of cobalt nitrate hexahydrate, 9.43 g of aluminum nitrate nonahydrate, and 4.99 g of zinc nitrate hexahydrate in 50 mL of a distilled water. A solution B was prepared by dissolving 6.34 g of sodium hydroxide (NaOH) and 1.00 g of sodium carbonate (Na₂CO₃) in 50 mL of a distilled water. The prepared solution A was dropped into the solution B to prepare a mixed solution, and then the mixed solution was left at 60° C. for 18 hours. Thereafter, the precipitates, that is, the filtered hydroxide, were obtained through a filter and washed with a distilled water at 90° C. until a pH thereof reached 7. After drying the washed hydroxide, the temperature was raised at a heating rate of 5° C./min and calcined in air at 450° C. for 4 hours to obtain a cobalt-zinc-aluminum mixed metal oxide catalyst of a hydrotalcite structure having M²⁺(Co, Zn)/M³⁺(Al)=2 and Ni/Zn=2.

### Experimental Example 1. SEM Analysis

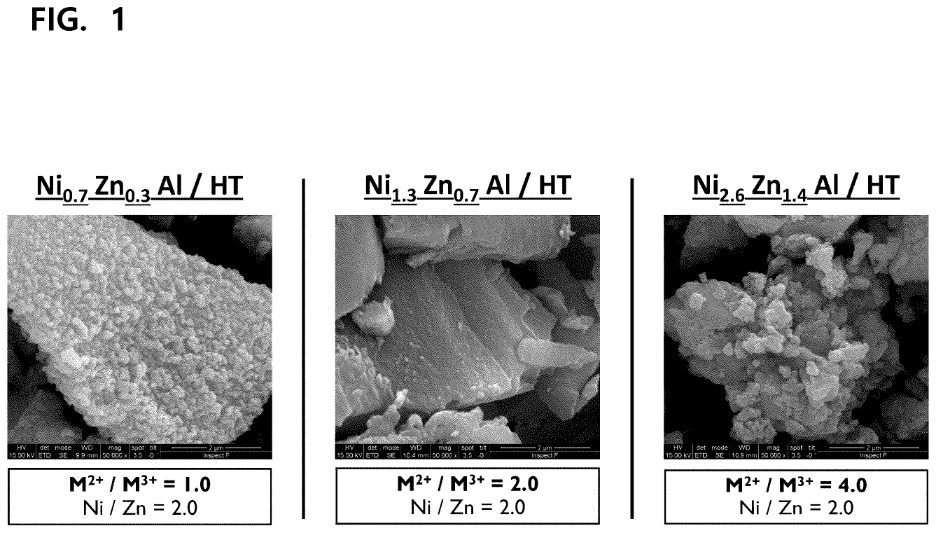

In order to observe a morphology of the catalysts prepared by Examples 1 to 3, the catalysts before calcination were analyzed using a scanning electron microscope (SEM), and the analysis results were shown in FIG. 1 (Analysis equipment: FEI Inspect F, FEI company, USA).

As shown in FIG. 1, the catalyst of Example 2 exhibited to have a relatively smooth surface. This means that all components of the catalyst are uniformly distributed, which can be seen that a more stable intermetallic compound has been formed. The catalysts of Examples 1 and 3 were observed to have surfaces of irregular shapes. This means that some components are not contained in the hydrotalcite structure. In addition, it can be inferred from this observation that different reducibility can be exhibited, as can be confirmed through a TPR (Temperature Programmed Reduction) analysis.

### Experimental Example 2. TPR Analysis

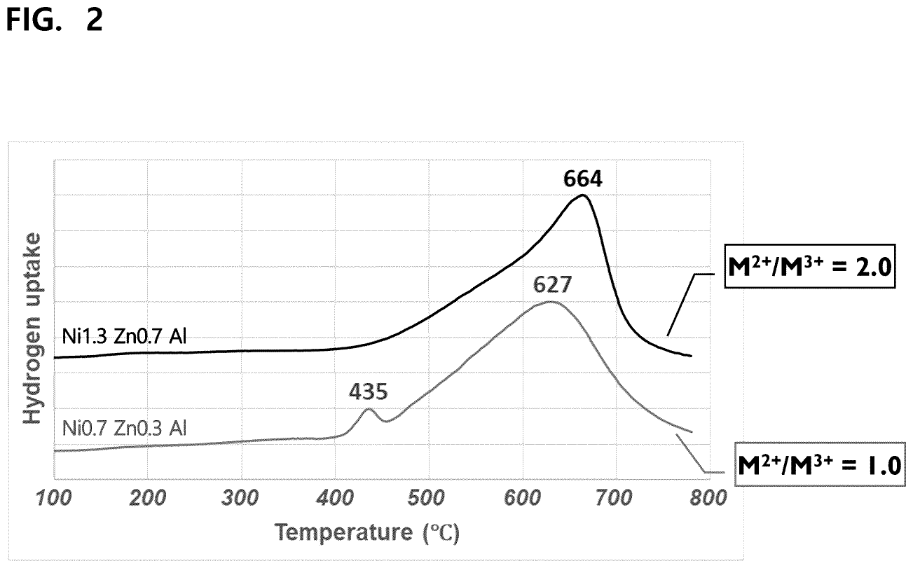

In order to confirm reducibility of the catalysts prepared by Examples 1 and 2, the calcined catalysts were analyzed by TPR (Temperature Programmed Reduction), and the analysis results were shown in FIG. 2 (Analysis equipment: Micromeritics 3Flex physisorption analyzer, Micromeritics, Inc., USA). 50 mg of the calcined catalysts were placed in a sample holder, and He was flowed therein at 50 ml/min. The holder was raised to a temperature of 200° C. at 10° C./min, maintained for 1 hour, and then lowered to a temperature of 50° C. Thereafter, 10% of H₂/Ar gas was flowed at 50 ml/min and purging was performed for 30 minutes, followed that the temperature was raised to 900° C. at 10° C./min, and the produced gas was measured with TCD.

For the catalyst of Example 1, two reduction peaks were observed. The peak at 435° C. is interpreted as the reduction of NiO, which interacts weakly with other metal species, and the peak at 627° C. is interpreted as the reduction of most NiO inside the catalyst. On the other hand, for the catalyst of Example 2, only one reduction peak was observed at 664° C. This means that there is a strong interaction between Ni and other metals by forming a uniform and more stable catalyst structure. Stronger interaction between the metals form a more stable catalyst structure and facilitate electron transfer between the metal elements, which can promote adsorption and activation of the reactants on a surface of the catalyst.

### Experimental Example 3. BET Analysis

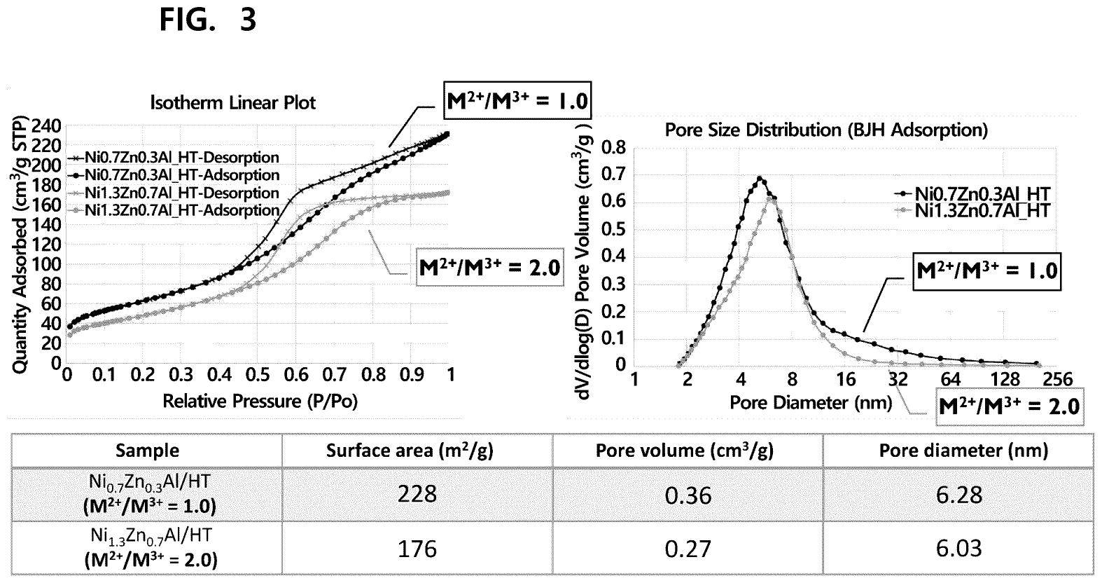

In order to confirm surface properties of the catalysts prepared by Examples 1 and 2, the catalysts after reduction was analyzed, and the analysis results were shown in FIG. 3 (Analysis equipment: BELSORP-mini II, BEL Japan Inc., Japan). The catalysts were reduced under 10% of a H₂/Ar gas atmosphere at 600° C. for 4 hours, and then analyzed by removing water vapor and adsorbed pollutants at 250° C. For the analyzed data, surface areas were calculated using a BET (Brunauer-Emmett-Teller) method, and pore sizes and pore structures were analyzed using a BJH (Barrett-Joyner-Halenda) method.

Both the catalysts of Examples 1 and 2 showed type IV isotherm curves indicating mesoporous characteristics. The catalyst of Example 2 showed a more uniform pore size distribution than the catalyst of Example 1. The uniform pore size distribution increases accessibility of the reactants to the active site, thereby making diffusion easier and providing better catalytic performance overall. Just as the catalyst of Example 1 showed an irregular shape from its surface observation result using SEM, the catalyst of Example 1 showed higher surface area and pore volume than the catalyst of Example 2.

### Experimental Example 4. STEM-EDS Analysis

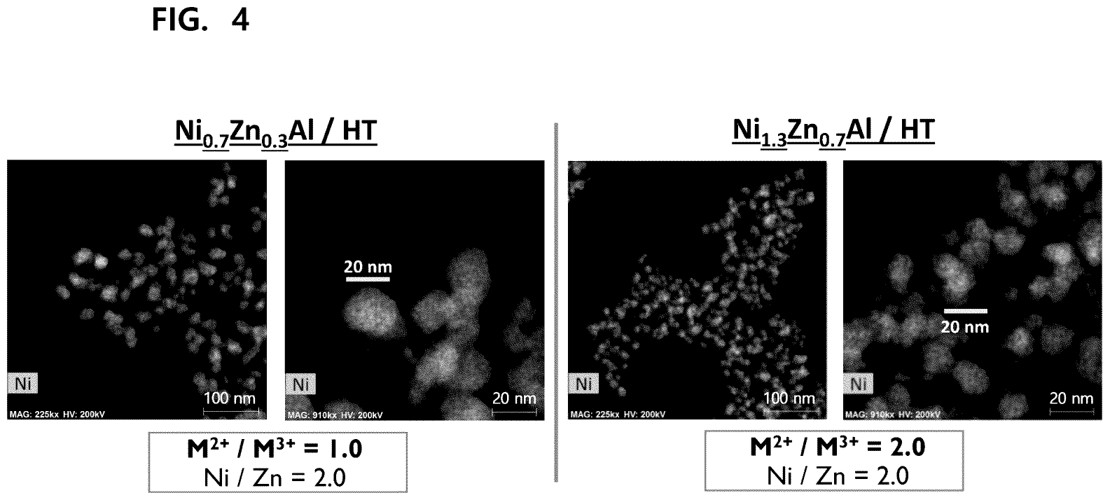

In order to confirm the nickel particles in the catalysts of Examples 1 and 2, the reduced catalysts were analyzed using a STEM-EDS (Scanning Transmission Electron Microscope-Energy Dispersive Spectrometer), and the analysis results were shown in FIG. 4 (Analysis equipment: Thermo Scientific Talos F200X, Thermo Fisher Scientific Inc., USA). The catalysts were reduced under 10% of a H₂/Ar gas atmosphere at 600° C. for 4 hours, and then analyzed by removing water vapor and adsorbed pollutants at 250° C.

The catalyst of Example 2 had a smaller average particle size (<20 nm) of Ni than the catalyst of Example 1, thereby showing high dispersion. This may be due to strong interaction between nickel and other metals in the catalyst. This interaction has an advantage of affecting the crystal formation and growth of Ni particles during reduction to improve the dispersion of Ni and Zn and make them more uniformly distributed on the catalyst surface. The above results may explain why there are no additional peaks observed in the TPR curve. The catalyst of Example 2, which showed only one reduction peak, has narrow reducibility and shows that it is possible to form a more stable catalyst.

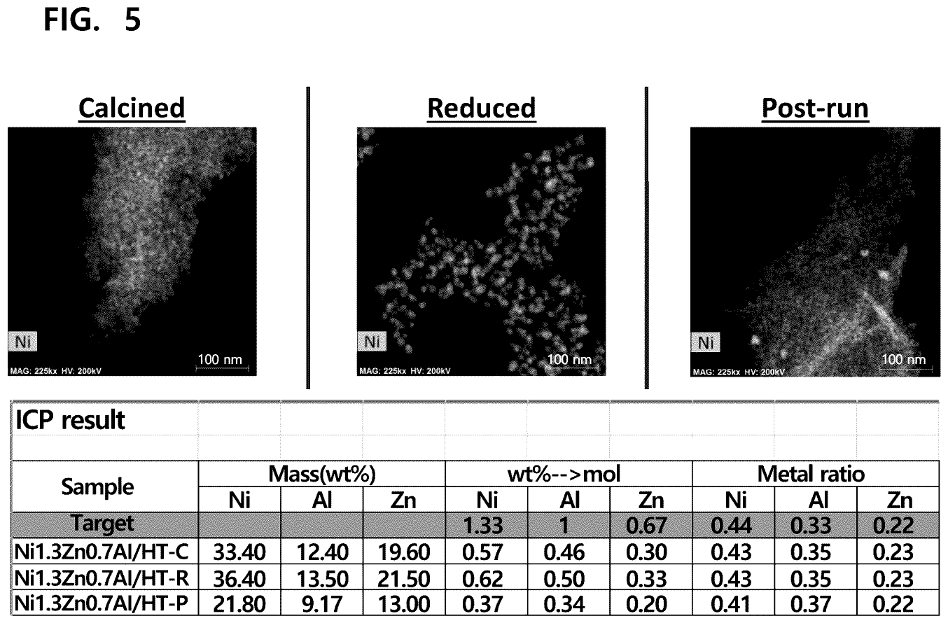

Further, in order to confirm a change in nickel particles after calcination and reduction of the catalyst of Example 2 and liquid phase reforming reaction of xylose, the catalyst was analyzed using STEM and EDS, and the analysis results were shown in FIG. 5.

During the calcination, all the metal components (Zn, Al) including nickel were converted to oxides and existed in dispersed forms in the support. During the reduction process, the oxides were eluted as a metal, and the metal particles agglomerated and grew. During the reaction, the harsh reaction conditions caused rearrangement of nickel particles, which results in smaller nickel particle size and redispersion. It is generally known that nickel is easily leached in an acidic solution. If referring to the ICP-OES (Inductively Coupled Plasma-Optical Emission Spectroscopy) analysis results, it could be confirmed that nickel was not detected even though the solution was acidic after reaction, and thus the nickel was not leached from the solid catalyst. The catalyst was found to be resistant to leaching as no leaching phenomenon occurred during the reaction.

### Experimental Example 5. Liquid Phase Reforming Reaction of Xylose

A liquid phase reforming reaction of xylose was simulated through an experiment using the catalysts of Examples 1 to 5 and Comparative Example 1. In order to conduct the experiment, 1 g of catalyst sample and glass beads were mixed and charged into a reactor. Then the reactor was first raised under a N₂ atmosphere to a temperature of 600° C., and then an Ar mixed gas containing hydrogen of 10 vol % was flowed into the reactor to perform reduction treatment for about 4 hours. Thereafter, a temperature and pressure inside the reactor were adjusted to 235° C. and 30 bar. After the temperature inside the reactor was stabilized, 1 wt % of liquid phase reactants uniformly dissolved were injected at 0.075 g/min. In this case, a product generated through the reaction was smoothly moved to a gas-liquid separator, to which N₂ was then constantly injected at a flow rate of 30 ml/min to determine a flow rate of the generated gas. After the generated gas product passed through the gas-liquid separator and a condenser, its composition was determined using a gas chromatograph (GC).

Meanwhile, a carbon conversion rate and a hydrogen selectivity in the liquid phase reforming reaction were calculated using the formulas below:

Carbon conversion rate to gas(C conversion;%)=100×(Total amount of moles of carbon compounds(carbon dioxide,carbon monoxide,methane,etc.)contained in the gas phase)/((Total amount of moles of xylose contained in the reactants)×5)

Hydrogen selectivity(H₂selectivity;%)=100×(Total amount of moles of hydrogen contained in the gas phase)/(Total amount of moles of carbon compounds(carbon dioxide,carbon monoxide,methane,etc.)contained in the gas phase)×1/Reforming ratio
wherein the reforming ratio (RR) is a variable that corrects for a difference in an amount of hydrogen produced depending on an injected biomass, and the reforming ratio for xylose is defined as 10/5.

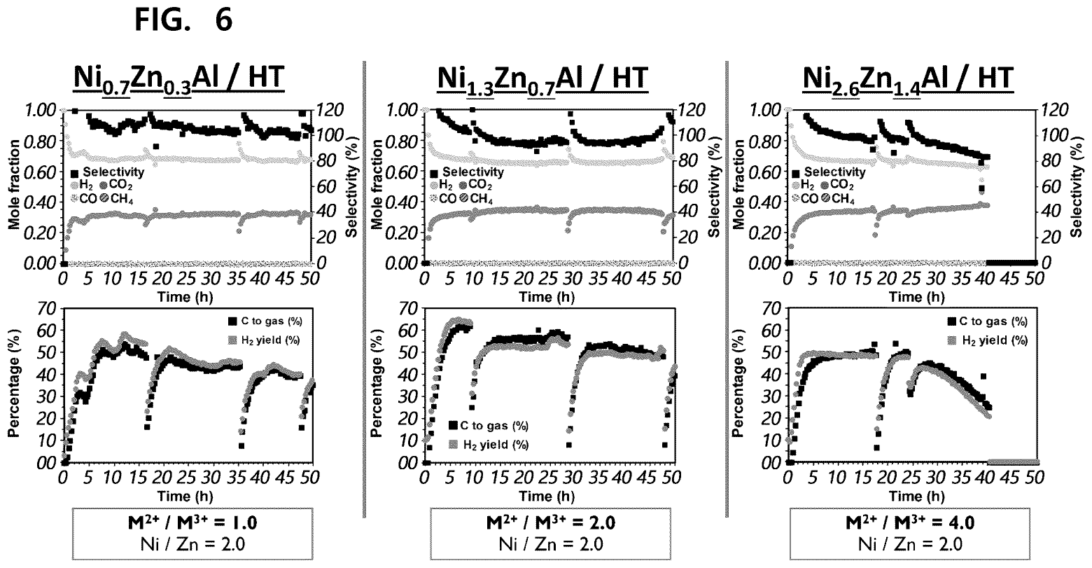

As a result, as identified by FIG. 6, the catalyst having a low M²⁺/M³⁺ molar ratio of 2 or less showed higher stability and hydrogen yield than the catalyst having a high M²⁺/M³⁺ molar ratio. In particular, the catalyst of Example 2 showed the best activity in the liquid phase reforming reaction of xylose.

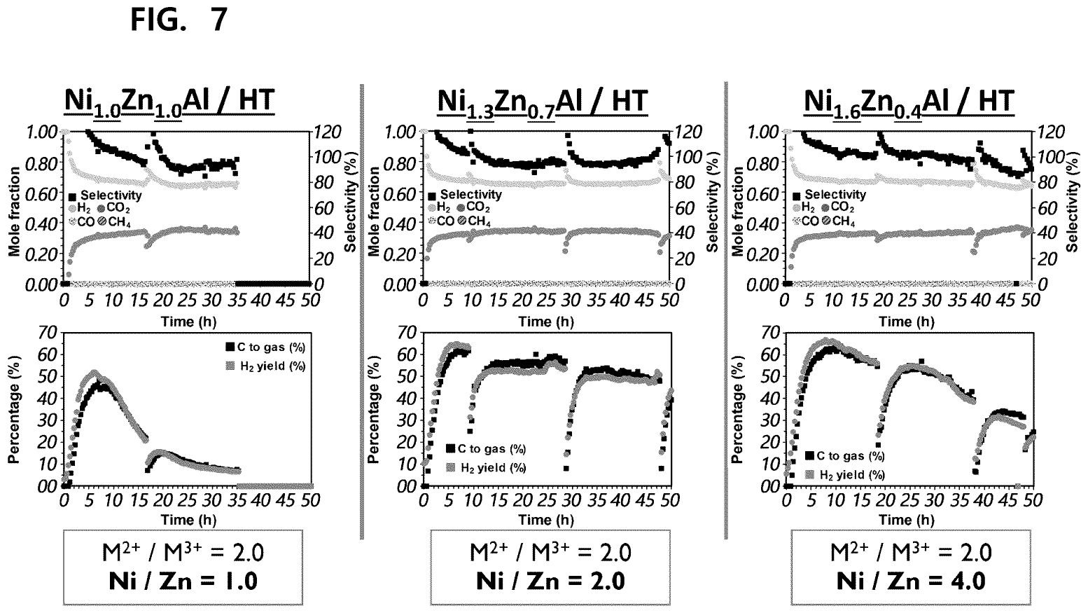

FIG. 7 shows results of the liquid phase reforming reaction of xylose using the catalysts of Examples 4, 2, and 5 in order from the left. As a content of the nickel metal increased, the catalytic activity increased, but as a content of the zinc metal decreased compared to that of the nickel metal, the stability decreased.

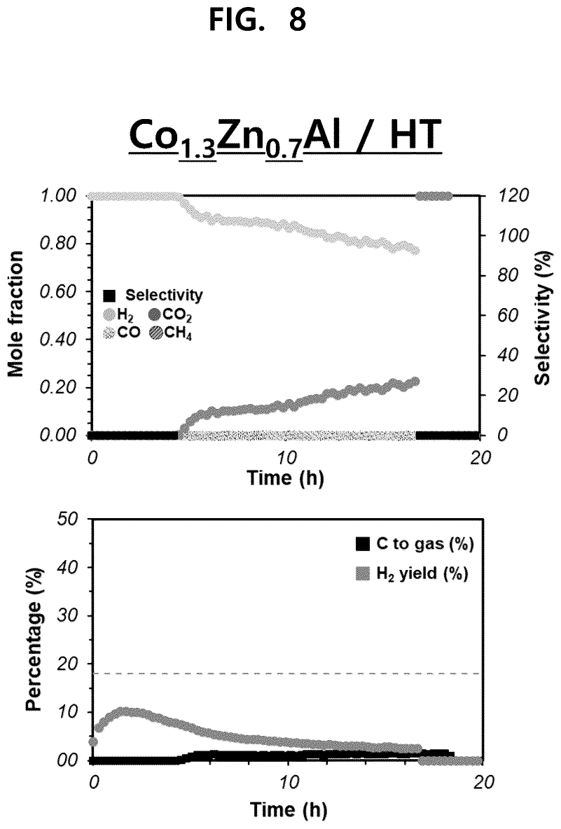

FIG. 8 shows results of the liquid phase reforming reaction of xylose using the catalyst of Comparative Example 1. It was confirmed that the carbon conversion rate and the hydrogen yield were significantly reduced.

As described above, specific technologies of the present disclosure have been described in detail. However, it will be obvious to those skilled in the art that these specific techniques are merely preferred embodiments and do not limit the scope of the present disclosure to the embodiments. Accordingly, the substantial scope of the present disclosure will be defined by the appended claims and their equivalents.

What is claimed is:

1. A mixed metal oxide catalyst, that is a nickel-zinc-aluminum mixed metal oxide of a hydrotalcite structure, and
is for liquid phase reforming of biomass.

2. The mixed metal oxide catalyst according to claim 1,
wherein a molar ratio of the mixed metal of nickel and zinc to the aluminum metal in the catalyst is 1 to 4.

3. The mixed metal oxide catalyst according to claim 1,
wherein a molar ratio of the nickel metal to the zinc metal in the catalyst is 2 to 4.

4. The mixed metal oxide catalyst according to claim 1,
wherein the catalyst is for liquid phase reforming of xylose.

5. The mixed metal oxide catalyst according to claim 1,
wherein the catalyst produces carbon monoxide and hydrogen from liquid reactants of biomass through the liquid phase reforming reaction of biomass, and the carbon monoxide reacts with water to produce hydrogen and carbon dioxide.
